(19) United States
(12) Patent Application Publication
(10) Pub. No.: US 2010/0071572 A1
(43) Pub. Date: Mar. 25, 2010

(54) WASTE COMPACTOR AND CONTAINER MONITORING SYSTEM

(76) Inventors: Robert B. Carroll, Brampton (CA); James R. Edwards, Mississauga (CA)

Correspondence Address: BUTZEL LONG;IP DOCKETING DEPT, 350 SOUTH MAIN STREET, SUITE 300, ANN ARBOR, MI, 48104, US

(21) Appl. No.: 12/565,379

(22) Filed: Sep. 23, 2009

Related U.S. Application Data
(60) Provisional application No. 61/099,401, filed on Sep. 23, 2008.

(51) Int. Cl. B30B 15/04

(52) U.S. Cl. 100/229 A

(57) ABSTRACT

A monitoring system for a waste compactor system comprising: a compacting device; at least one removable waste container; a compactor communications device for transmitting an indication of the fullness level of at least one receptacle or bin; a container communications device attached to the at least one removable waste container; a site monitoring unit to communicate with the container communications device and the compactor communications device.

### BACKGROUND

Example embodiments of the present invention relate to systems and methods for monitoring the operation of waste compactor containers.

Waste generators typically contract with waste haulers to pick-up and haul away accumulated waste. In some commercial arrangements, such contracts have provided for regularly scheduled pick-up times, which occur at pre-specified times, regardless of whether the waste container is full, not yet full, or whether the trash in the waste container has long since been overflowing the container. This can result in inefficiencies on waste pickups as they will often be conservatively scheduled to assure that most if not all of the regularly scheduled pick-ups occur when the waste container is not yet overflowing and generally when the waste container is not yet full.

Some commercial arrangements use an on-demand pick-up schedule in which the fullness of waste containers is remotely monitored. Such systems typically monitor the amount of force or hydraulic pressure applied to a ram for compacting the trash within a respective container over one or more compaction strokes. The measured force readings are then analyzed and a level of fullness is determined. When a determined level of fullness equals or exceeds the predefined threshold value for a set number of compaction cycles, the monitoring system initiates a pick-up request.

Example of monitored waste compactor systems are shown for example in U.S. Pat. Nos. 5,299,493; 5,393,642; 6,360,186; 6,408,261; 6,453,270; 6,561,085; 6,738,732; 5,299,142; and 7,145,459. The contents of these patents are incorporated herein by reference.

A waste management system that offers additional operational efficiencies, simplifies or reduces the cost of operating waste management systems that use compactor and container units is desirable.

### SUMMARY OF THE INVENTION

A monitoring system for a waste compactor system comprising: a compacting device; at least one removable waste container; a sensor for determining the fullness level of the receptacle or bin; a compactor communications device responsive to the sensor for transmitting an indication of the fullness level of at least one receptacle or bin; a container communications device attached to the at least one removable waste container; a site monitoring unit to monitor signals from the compactor communications device and the container communications device.

According to an example embodiment is an automated method for monitoring a waste compactor system that includes a compactor for compacting waste in a removable waste container, the method comprising: monitoring for compactor signals from a compactor monitoring unit indicating a fullness level status for the waste container; monitoring for wireless container signals from a waste container communications device secured to the waste container, the container signals including information for identifying the waste container; and determining status changes for the waste compactor system in dependence on the monitoring.

According to an example embodiment is a monitoring system for a waste compactor system having a compactor for compacting waste in a removable waste container, the monitoring system comprising a wireless communications device secured to the removable waste container and having an associated container sensor for detecting when the waste container is tipped at least a threshold tip angle, the communications device being configured to transmit one or more wireless signals indicating when the waste container has been tipped at least the threshold tip angle.

### BRIEF DESCRIPTION OF THE DRAWINGS

FIG. 1 is a block diagram of a waste management system in accordance with at least one embodiment of the present invention;

FIG. 2 is a flow diagram illustrating one aspect of the operation of a compactor tag of the waste management system of FIG. 1, according to an example embodiment;

FIG. 3 is a flow diagram illustrating one aspect of the operation of a waste generator site monitoring unit of the waste management system of FIG. 1, according to an example embodiment;

FIG. 4 is a flow diagram illustrating one aspect of the operation of a central monitoring station of the waste management system of FIG. 1, according to an example embodiment;

FIG. 5 is a flow diagram illustrating a further aspect of the operation of a central monitoring station of the waste management system of FIG. 1, according to an example embodiment;

FIG. 6 is a flow diagram illustrating a container removal monitoring process performed by a waste generator site monitoring unit of the waste management system of FIG. 1, according to an example embodiment;

FIG. 6A is a flow diagram illustrating an optional step for the container removal monitoring process of FIG. 6, according to an example embodiment;

FIG. 7 is a flow diagram illustrating a container arrival monitoring process performed by a waste generator site monitoring unit of the waste management system of FIG. 1, according to an example embodiment; and

FIG. 8 illustrates a data intake sheet for a waste generator using the waste management system of FIG. 1.

### DETAILED DESCRIPTION OF EXAMPLE EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

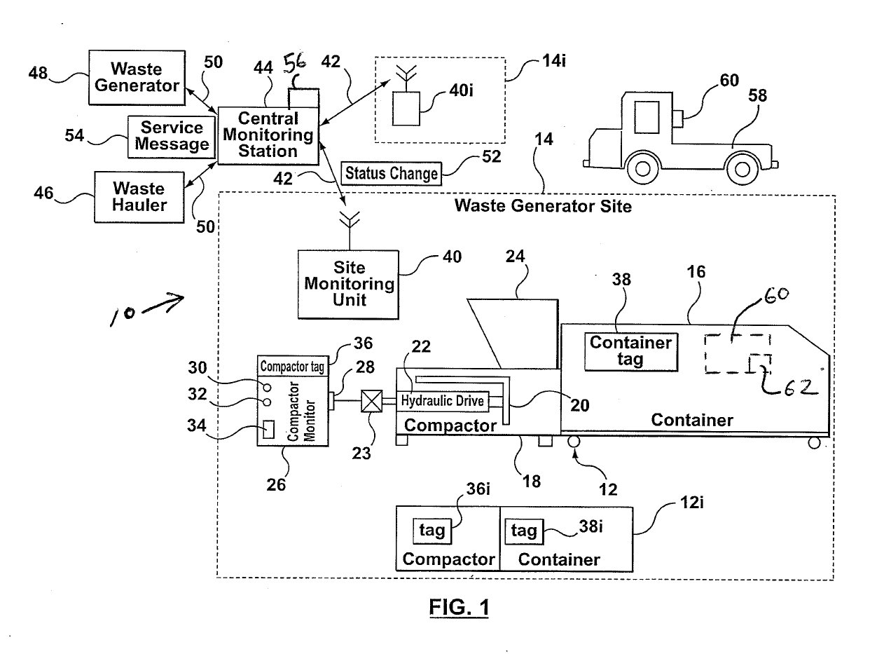

FIG. 1 illustrates a block diagram of an example of a waste management system 10 according to at least one embodiment of the present invention. The waste management system includes components at one or more one waste generator sites 14 that are monitored from a central monitoring station 44. The components at each waste generator site 14 include at least one waste compactor container unit, generally depicted by reference numeral 12, and a waste site monitoring device 40.

As shown in FIG. 1, each waste compactor container unit 12 includes a removable container 16 that is mounted to a compactor 18 having a hydraulic driver 22 which includes a ram 20 to compact waste received in container 16 through an inlet opening or chute 24. The hydraulic driver 22 receives pressurized hydraulic fluid from a hydraulic circuit 23 to effect reciprocal movement of the ram 20 in a controlled manner. The compactor 18 also includes a monitoring unit 26 that can monitor and provide an indication of the status of compactor 18. For example, the monitoring unit 26 may comprise a pressure sensor 28 for monitoring pressure in the hydraulic fluid path of the hydraulic circuit 23 for hydraulic drive 22. In a typical example embodiment, the monitoring unit 26 will be part of a compactor control unit that controls the operation of the hydraulic drive 22. In one example embodiment, the pressure sensor 28, which may for example include a pressure transducer and associated processing logic or circuitry, is configured to generate a signal when the pressure in the hydraulic circuit exceeds a predetermined threshold pressure setting or reading. For example, the predetermined threshold could be indicative of the ram pressure used when the container 16 is three quarters (¾) full, and the monitoring unit includes a visual status indicator in the form of a light 32 to provide a visual indication to an operator that the threshold has been met. In some example embodiments the pressure sensor 28 is configured to generate multiple signals, each indicative of a different predetermined threshold being reached, such as a first signal when a first threshold pressure level indicative of a ¾ level of container fullness is reached, and a second signal when a second threshold pressure level indicative of a full container is reached. In multiple threshold configurations, the monitoring unit 26 can include multiple indicator lights, for example ¾ full light 32 and full light 30 for indicating a ¾ fullness status and a full status of the container 16, respectively. In some example embodiments, the monitoring unit 26 is provided with an override or reset switch 34 for manually resetting the one or both of the status signals and visual indicators generated by the monitoring unit 26.

According to example embodiments, the compactor 18 includes a monitor unit wireless compactor communications device 36 secured to the compactor and associated with the monitoring unit 26 that periodically wirelessly transmits status information for the waste compactor container unit 12 to the waste site monitoring device 40. The container 16 also has attached to it a further container wireless communications device 38 that periodically wirelessly transmits information about the container 16 to the waste site monitoring device 40. In one example embodiment, the compactor monitoring unit wireless communications device 36 and container wireless communications devices 38 are each short range communications devices such as active RFID (“Radio Frequency Identification”) tags and the waste site monitoring device 40 is a corresponding active RFID reader, with the compactor tag 36 and the container tag 38 each communicating with the site monitoring device 40 using the ISM (“Industrial, Scientific and Medical”) radio frequency bands. Thus, in an example embodiment, the compactor tag 36 and container tag 38 each are programmable microprocessor enabled wireless communications devices having one or more onboard storage elements and including their own power source such as a battery. The compactor tag 36 may in some embodiments be connected to receive power from the compactor monitoring unit 26 to recharge its battery or for direct power. Other types of wireless communications devices communicating using other radio frequency or other types of wireless communications technologies could be used to implement communications devices 36, 38 and 40. In some embodiments, container tag 36 could be implemented using a passive RFID tag.

In one example embodiment, the compactor tag 36 is configured to monitor whether monitoring unit sensor 28 generates a signal (S1) indicating that the first threshold ram pressure has been reached or not in the most recent compacting cycle of the compactor. In an example embodiment, the signal S1 is a binary signal. For example, the compactor tag 138 can be electrically or otherwise coupled to the compactor monitoring unit 26 to detect when current is provided to the ¾ full light 32 on the monitoring unit, which can indicate whether the first threshold ram pressure was reached in the most recent compacting cycle or not. The compactor tag 36 is further configured to periodically send out a compactor beacon signal to the waste site monitoring device 40 that includes a current status of the compactor unit signal S1 (ex. “On” or “Off”) as well as a tag id (Compactor_Tag_ID). Depending on the capabilities of the compactor tag 36 other data could also be sent such as a tamper indicator, low battery indicator, or other performance data. The frequency with which the beacon signal is transmitted to site monitoring unit 40 can in at least some example embodiments be remotely configured from central monitoring station 44 in dependence on the requirements of the particular waste generator site 14.

Using a compactor tag 36 that monitors for the signal S1 used by monitoring unit 26 to drive indicator light 32 conveniently allows the compactor tag 36 to be easily connected to an existing compactor, as many compactor units will typically have a compactor light indicating a threshold pressure or fill level (such as ¾ full, for example) based on detected ram pressure—thus, adding compactor tag 36 simply requires connection of a wire or wires to detect current to a fill indicator light or other suitable signal line on a circuit board of the compactor monitor 26. Additionally, in such example embodiments, compactor tags 36 can easily be integrated into new compactor monitoring units 26 with little or no change to the design and operation of such units as the compactor tag 36 need only be connected to monitor a signal that the compactor monitor unit sensing logic has already been designed and configured to generate. Of course, in other example embodiments, the compactor monitor 26 may be configured to perform more advanced processing on hydraulic pressure data received through sensor device 28 rather than simply monitor for the presence of a driving signal to a fullness signal light (as described for example in some of the patents listed in the “Background” Section above), and in such embodiments the data gathered and sent by the compactor tag 36 may be more detailed than a simple indication as to whether the first threshold pressure was reached in the last compactor compacting cycle. The compactor tag 36 could also get information from the compactor monitoring unit 26 about the occurrence of compactor compression cycles and include that information in the compactor signals that it sends to the site monitoring unit 42, which in turn could relay the information to the central monitoring station 44 where the information could be used to send service messages requesting preventative maintenance of the compactor when predetermined cycle counts are reached. In some example embodiments, the compactor tag 36 could take the form of a printed circuit board integrated into a common housing as the compactor monitoring unit 26 and control circuitry for the compactor 18, and could monitor one or more operating parameters of the compactor 18 and include information about those monitored parameters in compactor signals sent to the site monitoring unit 40. One or more of the parameters may be indicative of a compactor fullness level, and some may be indicative of other operations aspects of the compactor.

In one example embodiment the container tag 38 is securely fixed to the wall of container 16 and periodically transmits a beacon signal that includes a unique container tag id (Container_Tag_ID) to the site monitoring unit 40. The frequency with which the container tag beacon signal is transmitted to site monitoring unit 40 can in at least some example embodiments be remotely configured from central monitoring station 44 in dependence on the requirements of the particular waste generator site 14.

The site monitoring unit 40 located at site 14 will typically have an associated wireless coverage area in which the compactor container unit 12 is located. In addition to compactor container unit 12, other compactor container units 12i having similarly configured compactor tags 36i and container tags 38i can also be located on site 14 within the coverage area of the site monitoring unit 40. In some configurations where a waste generator site 14 covers a large geographic area, there may be multiple site monitoring units 40 at a particular site, each having a respective coverage area including respective compactor container units 12i. In an example embodiment, the site monitoring unit 40 is a programmable microprocessor enabled device having one or more onboard storage elements and a wireless communications interface for communicating with compactor tags 26 and container tags 38 within it coverage area. The site monitoring unit 40 can also includes a communications interface for communicating over a communications link 42 with a remotely located central monitoring station 44. As noted above, in one example embodiment the site monitor unit 40 includes an active RFID reader, however it can be implemented using other processor enabled devices. As will be described in greater detail below, the site monitoring unit 40 collects information from the compactor tags 36 and container tags 38 within its coverage area, processes the collected information, and sends notifications and other information based on the processed information over communications link 42 to the central monitoring station 44.

The communications link 42 can include one or more of a cellular link, a Wi-Fi link, a wired PSTN (public switched telephone network), an internet link or other communications link. The central monitoring station 44 can be implemented using a server or other suitably configured computer, and as will be described in greater detail below, is configured to receive information from the site monitor 40 and other similar site monitors 40i that are located at waste generator site 14 and other waste generator sites 14i. In dependence on the received information, the central monitoring station 44 sends notifications to one or both of waste generator communications devices 48 and waste hauler communications devices 46 over one or more communications links 50. Waste generator communications devices 48 are devices that are used to communicate with a person or people responsible for the operation of waster generator sites 14, 14i, and waste hauler communications devices 46 are devices that are used to communicate with a person or people responsible for hauling containers from the sites or sites 14, 14i. Such device could for example include a fax machine, or device capable or receiving one or more of email messages, text messages or voice messages. Communications link(s) 50 can include one or more of a cellular link, a Wi-Fi link, a wired PSTN (public switched telephone network), an internet link or other communications link.

In at least some example embodiments the central monitoring station 44 has access to an operations database 56 that is either locally stored on a storage element of the central monitoring station or available through a communications link to the central monitoring station which stores data used for operation of the waste compactor and container network 10. For example, the operations database 56 can include a list of all compactor tag ID's for the compactor tags that are associated with the waste management system 10, with each unique compactor tag ID being associated in the database with one or more of: (a) a ID number for the compactor and container unit 12 that compactor tag 36 is attached to; (b) identification information for the site monitoring unit 40 that the compactor tag 36 communicates with; (c) information identifying the location of the waste generator site 14 that the compactor tag 36 is located at; (d) information identifying waste generator that is using compactor and container unit 12 and rules and information for communicating with the waste generator communications devices 48; (e) information identifying the waste hauler responsible for compactor and container unit 12 and information for communicating with the waste hauler communications devices 48; (f) business rules for issuing service messages for the compactor and container unit 12 that compactor tag 36 is attached to, including information about the various duration and number of repetition thresholds that are described in greater detail below; (g) information identifying the containers 16 (and/or the container tag ID for such containers) used with the compactor and container unit 12; and (h) information specific to the current or historical health of the associated tags or readers such as low battery alerts, tamper alerts, power-up resets, communications restrictions or failures, etc.

On overview of waste management system 10 having been provided, operation of the system and its various sub-systems according to example embodiments will now be described in greater detail.

Request for Container Servicing

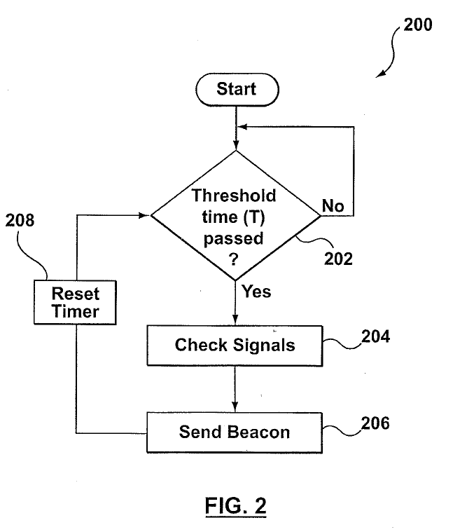

Operation of the waste management system 10 to arrange for servicing of a full container 16 will now be described. First, with reference to the flow diagram of FIG. 2, a compactor monitoring process 200 performed by the compactor tag 36 according to at least one example embodiment includes the following. The compactor tag 36 is configured to wait a predetermined time duration (step 202), then check to see if the compactor monitoring unit 26 is generating signal 51 (step 204) which indicates if the ram pressure for the compactor exceeded a threshold value during its most recent compacting cycle. As noted above, this could for example be done by checking to see if the signal S1 used to drive the ¾ full indicator light 32 has been activated. After checking the status of signal S1, the compactor tag 36 then sends a beacon signal that includes the current status of signal S1 (for example “On” or “Off”) as well as the unique compactor tag ID (Compactor_Tag_ID) to the site monitoring unit 40 (step 206). The timer used in step 202 is reset (step 208), and the compactor tag process 200 is repeated. Accordingly, as will be understood from process 200 as described above, in one example embodiment, the compactor tag 36 periodically sends a beacon signal to the site monitoring unit 40 that identifies the compactor tag 36 and the latest status of the signal S1. In one example embodiment, the threshold time used in step 202 can be remotely set through instructions received from central monitoring station 44 via the site monitoring unit 40 such that the frequency with which the beacon messages are sent by the compactor tag 36 can be remotely configured for the operating conditions of the compactor container unit 12. For example, in some cases the threshold time could be set to one minute, while in other cases the time could be less than or greater than one minute. In some example embodiments, the compactor tag 36 could alternatively be configured to only send a beacon signal to the site monitoring unit 40 when there is a change in the status signal S1, or only when interrogated by the site monitoring unit 40.

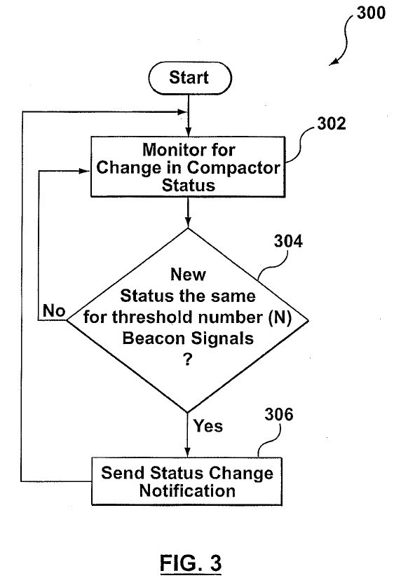

The site monitoring unit 40 is configured to monitor the periodic beacon signals received from compactor tag 36 to determine when there is a change in compactor status based on a predetermined number of readings of signal S1 taken at the compactor monitoring unit 26 and then notify the central monitoring station 44 of any detected change in compactor status. By way of example, FIG. 3 shows a block diagram that represents one possible compactor status change monitoring process 300 that can be performed by the site monitoring unit 40. Change monitoring process 300 will be described in the context of a single compactor tag 36, however the process 300 is continuously performed by the site monitoring unit 40 for each of the compactor tags 36, 36i that are assigned to site monitoring unit 40 and within the site monitoring unit's 40 coverage area. In process 300, the site monitoring unit 40 monitors the beacon signal received from compactor tag 36 to determine if there is a possible change in the compactor status information between successive beacon signals (step 302). For example, if compactor tag 36 sends a succession of beacon signals each indicating that as an initial state the compactor status signal S1 is “OFF” (e.g. indicating that hydraulic pressure provided to compactor ram 20 has not yet hit the predetermined compactor pressure), and then sends a beacon signal indicating that the compactor status signal S1 is “ON” (indicating that the threshold hydraulic pressure was hit in the most recent compacting cycle), then the site monitoring unit 40 will determine that a change in compactor status information has been detected.

Once a change in the compactor status information is detected, the site monitoring unit 40 is configured to track successive beacon signals to determine if the updated compactor status information then stays the same for a threshold number of successive beacon signals from the compactor tag 36 (step 304). For example, once the beacon signal changes to indicate the compactor status signal S1 is “ON” (indicating that the threshold hydraulic pressure was hit in the most recent compacting cycle), then the site monitoring unit 40 will continue monitoring a threshold number of successive beacon signals received from the compactor tag 36 to track if they also indicate that the compactor status signal S1 is “ON”. By way of non-limiting illustrative example, the threshold number could be 5, such that in the case where the compactor tag 36 sends a beacon signal every minute the compactor signal S1 must be “ON” for five minutes before the site monitoring unit 40 will conclude in step 304 that the new compactor status has remained the same for a threshold number of beacon signals. In the event that the compactor status signal remains the same for the threshold number of beacon signals, then the site monitoring unit 40 sends a compactor change status notice to the central monitoring station 44 (step 306). In the event that the compactor status does not remain the same for the threshold number of beacon signals, for example, if the beacon signal changes to indicate the compactor status signal S1 is once again “OFF” (indicating that the threshold hydraulic pressure was not hit in the most recent compacting cycle), the compactor status change notice is not sent and the site monitoring unit returns to step 302 to once again monitor for a future change in the compactor status information.

Although the compactor status change monitoring process 300 has been described above primarily in the context of a change on the compactor signal S1 from an initial “OFF” state to an “ON” state, the process 300 similarly monitors for a change from an initial “ON” state to an “OFF” state and sends status change notification messages 52 for such changes.

Accordingly, in the presently described embodiment the compactor tag 36 is configured to periodically send a beacon signal to the site monitor 40 every (T) minutes (or seconds). The beacon signal includes the compactor tag ID and compactor status information that indicates the current status of signal S1 generated by the compactor monitoring unit 26 which in turn is indicative of the whether or not the hydraulic drive 22 hit a threshold pressure level (P) during the compactor's most recent compression cycle. The site monitoring unit 40 is in turn configured to monitor for a change in the compactor status information between received beacon signals. Once a change in compactor status information is detected, the site monitoring unit 40 then tracks the compactor status information to see if it remains the same for a threshold number (N) of successive beacon signals, and if so it sends a status change notification message 52 to the central monitoring station 44. If the compactor status information reverts back to its former state before the number of received beacon signals hits the threshold number (N), the status change notification message 52 is not sent. Thus, in the presently described example embodiment, when the state of the compactor signal S1 changes and then stays changed for at least (N)*(T) minutes (the threshold number of beacon signals in step 304 multiplied by the time between beacon signals from step 202), a status change notification message 52 is sent from the waste generator site 14 over communications link 42 to the central monitoring station 44.

The delay of (N)*(T) minutes can mitigate against premature notification being provided to the central monitoring station of a change in compactor status. For example, some refuse in the container 16 may take multiple compression cycles to properly compress, with the result that the hydraulic ram pressure for one or two compression cycles may jump up to the threshold level (P) and then subsequently go back below the threshold level in a subsequent compression cycle that occurs within the delay time (N)*(T) minutes, in which case no change in compactor status notification is sent to the central monitoring station. Also, in some example embodiments, the hydraulic ram pressure may exceed the threshold level (P) and cause indicator light 32 to go on (and change in signal S1 from “OFF” to “ON”) but a local site operator may decide within the delay time (N)*(T) minutes that the container 16 still has capacity and thus use reset switch 34 to override or reset the monitoring unit 26 and turn off the indicator light 32, pushing signal S1 back to its “OFF” state and thereby aborting sending of the compactor status change notification to the central monitoring station 44. Conversely, in the situation where the signal S1 was previously in an “ON” state a sufficient time to cause a compactor status change notification to have already been sent to by site monitoring unit 40 and an operator then hits the reset button 34 causing a temporary change in signal S1 from “ON” to “OFF” until the next compression cycle, the temporary change will not result in a further status change notification message 52 being sent provided the next compression cycle occurred within the within the delay time (N)*(T) minutes; thus, in such a situation premature notification of the compactor changing from a full state to a not full state can be avoided.

In example embodiments, one or both of the number of beacon signals (N) and the beacon signal period time (T) can be remotely configured from the central monitoring station 44 so that the delay time can be configured for the specific operating environment of the compactor container unit 12.

In at least some example embodiments, the status change notification message 52 sent by the site monitoring unit to the central monitoring station 44 includes the compactor tag ID for the relevant compactor tag 36 and provides an indication that a change in the state of the compactor status has occurred. In some cases, the compactor status change notification may identify the current changed state of the compactor—for example indicating that the compactor has reached a “full” status when the compactor ram pressure goes above the threshold pressure P for the threshold number of beacon signals, and a “not full” status when the compactor ram pressure drops below the threshold pressure P for the threshold number of beacon signals.

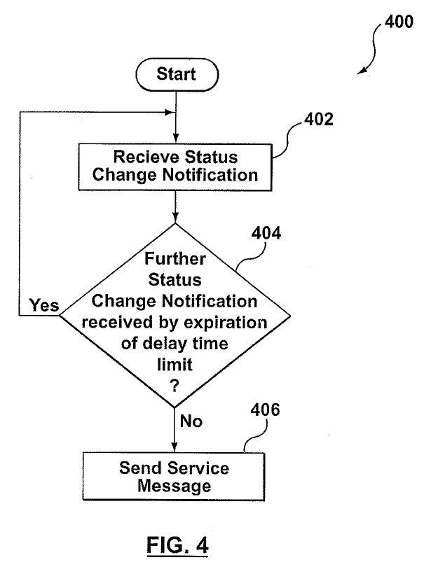

According to example embodiments, the central monitoring station 44 is configured to perform a status change monitoring process 400, illustrated generally in FIG. 4, during which compactor status change notification messages 52 received from site monitoring units 40, 40i are monitored to determine if service messages 54 need to be sent out to one or more waste generator communications devices 48 and/or one or more waste hauler communications devices 46. In particular, once the central monitoring station 44 receives a compactor status change notification message 52 for a specific compactor tag 36 (step 402), it records the time of receipt and then waits for a threshold wait time (step 404) for another compactor status change notification message 52 for the subject compactor tag 36. If no further compactor status change notification is received by the central monitoring station 44 during the threshold wait time, then the central monitoring station will proceed to send out a service message 54 for the compactor and container unit 12 that the compactor tag 36 is attached to (step 406). However, if in step 404 another compactor status change notification message 52 for the subject compactor tag 36 is received from the site monitoring unit 40 within the threshold wait time, the central monitoring station 44 aborts the countdown and does not send a service message 54.

Turning again to step 406, in the event that a service message 54 is sent, the service message 54 will be sent to one or more waste hauler communications devices 46 and/or one or more waste generator communications devices 48 in dependence on rules specified in the operations database 56. For example, the service message 54 could be sent by one or more of fax, text message or email message to communications devices 46, 48 associated with the generators or haulers responsible for generator site 14.

In the case where the compactor status change message 52 received in step 402 indicates a “Full” status, and a subsequent status change message 52 is not received during the threshold wait time in step 404, then the service message 54 sent in step 406 will include a service request that identifies the compactor and container unit 12 that is in need of servicing and the site 14 at which the compactor and container unit 12 is located (such information can be stored in the operations data base 56 associated with the container tag ID so that it can be retrieved and included in the service message 54. For example, the service message 54 could contain the following text sent one or more of fax, email, or text messaging to predetermined waste hauler and/or waste generator devices: “The Air System (Shred) Compactor located at Acme Printing, 10 Queen Street, Toronto Ontario requires service”. Thus, in such an example, in operations database 56 the container tag ID links to compactor identifying information: “Air System (Shred) Compactor” and to site identifying information: “located at Acme Printing, 10 Queen Street, Toronto Ontario”. The time that service message 54 is sent can be tracked and stored by the central monitoring station 44, for example in operations database 56. The parties receiving the message can then make arrangements for the subject container 16 to be emptied.

By way of non limiting illustrative example the threshold wait time in step 404 could be 55 minutes. In example embodiments, the wait time can be set by an administrator based on requirements of the particular waste compactor container unit 12 that is associated with the subject computer tag 36. The threshold wait time in step 404 further mitigates against premature sending of service messages 54. By way of example, “bridging” can occur in some cases when an empty or nearly empty container 16 is initially filled with waste such as cardboard, meaning that the waste can form a layer on the bottom of the container 16 that resists compaction for several cycles of the hydraulic ram 20 until the bridge is broken. Accordingly, it is possible in a bridging condition that the site monitoring unit 40 could send a compactor status change notification 52 to the central monitoring station 44 for a container 16 that still has lots of capacity but appears full (from the perspective of ram pressure) due to the bridging. The threshold wait time that the central monitoring station 44 waits between receiving the compactor status change notification 52 and prior to sending out a service message 54 provides time, at least in some cases, for the bridge to break and the site monitoring unit 40 to send a subsequent compactor status change notification 52 advising the central monitoring station 44 that the compactor container 16 has changed back to “not full”, thereby aborting an unnecessary service message 54.

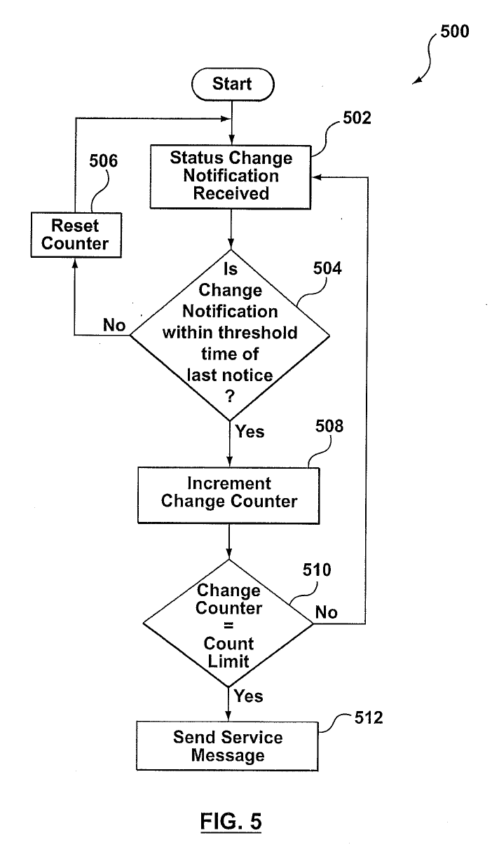

In some example embodiments additional or alternative criteria can also be applied at the central monitoring station 44 to determine if a waste compactor and container unit 12 is in need of servicing. By way of example, as noted above in some compactor systems an operator can reset or override the threshold pressure indicator light 32 (and thus status signal S1) by using reset switch 34 (or in some cases by turning the compactor on and off). In some situations, constant resetting and overriding may result in situations where the site monitoring unit 40 keeps sending new status change notification messages 52 to the central monitoring station 44 before the threshold wait time in step 404 of monitoring process 400 expires, such that a timely service message 54 may be difficult to generate using process 400 on its own. In this regard FIG. 5 shows a status change frequency monitoring process 500 that in one example embodiment is performed by the central monitoring station 44 in parallel with and supplemental to process 400 to mitigate against situations where operators may be prone to overuse of a compactor alarm reset or override feature.

In a status change frequency monitoring process 500 (FIG. 5), after a compactor status change notification message 52 is received from a site monitoring unit 40 in respect of a particular compactor tag 36 (step 502), the central monitoring station 44 is configured to check if the most recent compactor status change notification message 52 was received within a threshold time since the last compactor status change notification message 52 for the subject compactor tag 36 (step 504). If the delay between the successive notification messages 52 is greater than the threshold, then a change counter is set to zero (step 506), and the process 500 restarts. However, in the event that the delay between the successive notification messages 52 is less than the threshold, then a status change counter is incremented (step 508) and a determination made if the status change counter has hit a predetermined limit (step 510). If the status change count limit has not been hit, then central monitoring station returns to step 502 to wait for and eventually receive the next status change notification message 52. However, in the event that the change count limit has been reached, the central monitoring station 44 is configured to send out a service message 54 requesting that the compactor container unit 12 be serviced.

Thus, as illustrated by status change frequency monitoring process 500, in one example embodiment the central monitoring unit 44 is configured to monitor the pattern of compactor status change notification messages 52 received in respect of a compactor tag and determine if a service message needs to be sent. In the illustrated embodiment, the central monitoring unit 44 will determine that a service message needs to be sent for a compactor container unit 12 if a threshold limit of successive compactor status change notification message are received for the compactor container unit with each of the successive messages 52 being received within a threshold time limit of the immediately preceding status change notification message 52. By way of non-limiting illustrative example, the status change count limit could be 5, with the time limit between successive message being 1 hour such that if the sequence of the following five status change messages: “Full”-“Not Full”-“Full”-“Not Full”-“Full” was received with no more than 60 minutes between each successive pair of messages a service message for the subject compactor container unit 12 would be triggered once the last “Full” message in the sequence was received. In example embodiments the time and number limits used in process 500 can be configured for the needs of a specific compactor container unit 12.

In another example embodiment, change frequency monitoring process 500 tracks pairs of status change messages rather than just signal status change messages such that the occurrence of a series of pairs of status change messages, with each pair being received within a threshold time of the previous pair will result in a service request message being sent. For example, successively receiving the status change message pairs “Full; Not Full”-“Full; Not Full”-“Full; Not Full”-“Full; Not Full”-“Full; Not Full” for a compactor tag 36, with each “Full; Not Full” pair being received within a threshold time limit of the previous “Full; Not Full” pair will result in a service request message being sent.

Notification that Container is being Serviced

Typically, once a service message 54 identifying that a particular compactor container unit 12 needs servicing has been sent a truck 58 (FIG. 1) will then be dispatched to the waster generator site identified in the service message to pick up the container 16 that is attached to the identified compactor container unit 12.

In example embodiments, as will now be described, the above mentioned container tag 38 provides a mechanism by which the central monitoring station 44 can track when a container has been removed for servicing and when servicing of a compactor container unit is complete.

As noted above, in an example embodiment, the container tag 38 is also configured to periodically send a beacon signal to the site monitoring unit 40 that includes a unique container tag ID (Container_Tag_ID). Additionally, the container tag 38 could also include a sensor such as an accelerometer and information from the sensor about the container could also be sent as part of the beacon signal or another signal. For example, in some applications the beacon signal could be transmitted every minute, while in other cases the time could be less than or greater than one minute. In some example embodiments, the time period can be remotely set through instructions received from central monitoring station 44 via the site monitoring unit 40. In some example embodiments, the container 38 could alternatively be configured to only send a beacon signal to the site monitoring unit 40 when interrogated by the site monitoring unit 40.

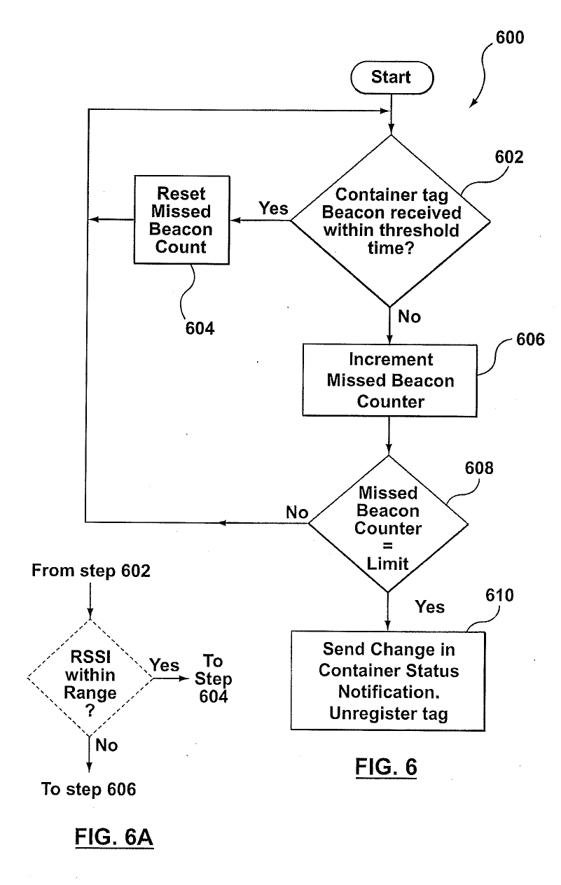

FIG. 6 illustrates a container monitoring process 600 that is performed by the site monitoring unit 40 in order to detect when servicing of a compactor container unit 12 has commenced. Although described herein the context of a single container tag 36, the process 600 will be carried out by the site monitor 40 in respect of all waste compactor container units 12 that are in its coverage area. At the start of container monitoring process 600 in respect of a specific waste compactor container unit 12, the site monitoring unit 40 has previously registered that the container tag 38 (and thus container 16) is within its coverage area and is associated with a specific waste compactor 18. The process by which the site monitor 40 registers a specific container tag 38 as being within its coverage area will be discussed in greater detail below under the heading “Notification that Servicing is Complete”.

Referring now to steps 602 and 604 of FIG. 6, monitoring process 600 begins with the site monitoring unit 40 monitoring for a periodic beacon signal transmissions from a container tag 38 that has previously registered with the site monitoring unit 40. In one example embodiment the site monitoring unit 40 has been configured to expect a periodic beacon signal from the container tag 38 within a threshold time duration, for example once every minute (in example embodiments, such time duration can be configured back at the central monitoring station 44). In the event that the container tag beacon signal is received within the expected time threshold than a missed container beacon counter is reset and the site monitoring unit 40 continues to monitor for subsequent container tag beacon signals. If however an expected container beacon signal is not received within the expected threshold time duration, the missed container beacon signal counter is incremented (step 606) and compared against a missed beacon threshold (step 608). If the number of missed beacon signals falls below the threshold, the site monitoring unit 40 continues to monitor for further beacon signals from the container tag 38 (step 602). If however the number of missed beacon signals for the container tag 38 reaches the missed beacon threshold, then the site monitoring unit 40 sends a status change notification message 52 to the central monitoring station 44 in respect of the container tag 38 (step 610). In example embodiments, the status change notification message 52 will include the container tag ID 38 as well as an indication of the nature of the change in status, for example that the container tag 38 (and hence container 16) has been moved away from the waste compactor container unit 12.

Accordingly, in container monitoring process 600, when the site monitoring unit 40 fails to receive any beacon signals from container tag 38 a predetermined duration (e.g. the threshold time in step 602 multiplied by the missed beacon count threshold) then a preliminary assumption is made that the associated container 16 has been moved from its location on the waste compactor container unit 12 for emptying, and a status change notification message 52 is sent to notify the central monitoring station 44 of the change. More generally, when the communications (or lack thereof) between the container tag 38 and the site monitoring unit 40 are indicative of the removal of the associated container 16, a status change notification message 52 is generated advising of the change.

In some example embodiments, the site monitoring unit 40 may perform more than a simple presence test in determining if a change in container tag status has occurred. For example, FIG. 6A shows an optional step that can be inserted between steps 602 and 604 of the container monitoring process of FIG. 6 in which an RSSI (Received Signal Strength Indicator) of the beacon signal from container tag 38 is analyzed to determine if the container 16 has been moved off of the waste compactor container unit 12 but is still within range of the compactor tag 36, as may occur for example in a generator site 14 where multiple or “swing” containers are available. If in step 602 a determination is made that a beacon signal is received within the threshold time, then prior to resetting the missed beacon counter in step 604, an intermediate step 612 is performed to determine if the RSSI for the container tag beacon signal falls within a signal strength range that would be expected if the container tag 38 was on a container mounted to the waste compactor container unit 12. If the RSSI is within the expected signal range, an assumption is made that the container 16 has not yet been moved for servicing, and the process 600 continues with step 604. However, if the RSSI for the container tag signal falls outside the expected range then the missed beacon counter is incremented and compared against the threshold (steps 606 and 608). Accordingly, in the combined process of FIGS. 6 and 6A, when the site monitoring unit 40 fails to receive any beacon signals at all or which fall within a expected RSSI value for a predetermined duration (e.g. the threshold time in step 602 multiplied by the missed beacon count threshold) then a preliminary assumption is made that the associated container 16 has been moved from its location on the waste compactor container unit 12, and a status change notification message 52 advising of such is sent to notify the central monitoring station 44 of the change. The expected signal strength range used step 612 could be pre-calibrated during system set up or could for example be dynamically determined with comparison to the RSSI for beacon signals received from the compactor tag 36.

Central monitoring station 44 is configured to monitor for and process status change notification messages 52 advising of the removal of container tags 38 in a similar manner that it monitors for and processes status change notification messages for compactor tags 36, as described above with reference to status change monitoring process 400 illustrated in FIG. 4. For example, once a status change notification message 52 advising of a change in status of a container tag 38 is received (step 402), the central monitoring station waits for a predetermined time duration for another status change notice advising of a further change in status of the container tag 38 (step 404), and if no further status change notice is received in respect of the container tag 38, then a service message 54 is then sent out to one or more waste hauler communications devices 46 and/or waste generator communications devices 48. However, if a further status change notice is received in respect of the container tag 38 then the service message 54 is not sent.

The predetermined waiting time applied in step 404 for a subsequent status change notification message 52 for container tag 38 (and its container 16) can be different than the waiting time in respect of a change in status notification message for a compactor tag 36—by way of non limiting illustrative example, the time limit could be 10 minutes, or such other amount as set by a system administrator to meet the operating requirements of waste generator site 14. One purpose of the delay in sending the service message 54 is to account for a momentary loss of communication between the container tag 38 and the site monitoring unit 40 that could occur for transient reasons other than removal of the container for dumping—for example due to transient blocking of wireless communication between the container tag 38 and the site monitoring unit 40, or due to quick removal and replacement of an un-emptied container due to hauler error. Accordingly the delay in step 404 can prevent premature notification that a container has been removed for servicing; if the central monitoring station 44 first receives a status change notification message 52 advising that a container tag 38 has been removed from a compactor and container unit, and then subsequently within the delay time in step 404 receives a subsequent notice that the container tag 38 has been returned to the compactor and container unit 12 an assumption is made that the container 16 associated with the container tag 38 has not been dumped and so the service message is not sent out.

In cases where a service message is sent in respect of a removed container 16, the service message 54 will be sent in dependence on information stored in operations database 56. For example, the container tag 38 can be linked in the operations database 56 to identification information for the waste compactor and container unit 12 that it was mounted on prior to its recent removal, and to information defining what waste hauler communications devices 46 and/or waste generator communications devices 48 should be provided with service message 54 over what medium. An illustrative example of the content of a service message 54 sent advising that a compactor and container unit is being services is as follows: “The Bin #C97 Located at Acme Printing, 10 Queen Street, Toronto, Ontario has been removed for service”.

The receive time and content of the status change notification message 52 advising of the container removal and/or the send time and content of the service message 54 advising of container servicing can be stored in operations database 56 for future performance analysis.

Notification that Servicing is Complete

According to example embodiments, when a container 16 is returned to its waste compactor container unit 12 after being emptied the return of the container 26 is detected by and registered with site monitor 40 and reported to central monitoring station 44, which then sends a corresponding service message advising the appropriate waste hauler and or waste generator the corresponding compactor and container unit 12 has been serviced.

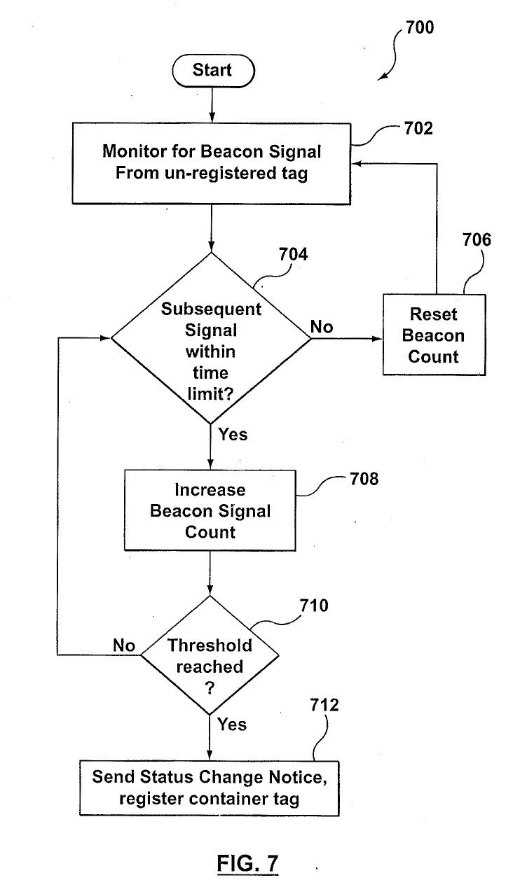

In this regard, FIG. 7 illustrates a sample of a container arrival monitoring and registration process 700 that is performed by the site monitoring unit 40 according to example embodiments. Process 700 can be performed by site monitoring unit 40 in respect of each compactor and container unit within its coverage area for which the site monitoring unit 40 has previously sent a status change notice message advising that a container tag 38 has been removed from the proximity of a compactor and container unit 12.

As indicated in step 702, the site monitoring unit 40 monitors for a beacon signal from a container tag 38 that is not currently registered with the site monitoring unit 40 (for example a container tag 38 that has recently come into the coverage area of the site monitoring unit 40 and which is not known to currently be mounted on a compactor and container unit 12). If such a beacon signal is acquired, the site monitoring unit 40 then waits for a subsequent beacon signal to be received from the newly acquired container tag 38 within a threshold time duration (step 704). If a subsequent beacon signal is received, then a beacon signal counter is incremented (step 708) and compared against a beacon count threshold (step 710). If the threshold is met, then a change in status notification message 52 is sent to the central monitoring station 44 advising of the container tag ID that has been newly acquired, and the container tag ID is registered with the site monitoring unit 40 as a container tag that it is currently monitoring (step 712). In the event that the threshold number of beacon signals each are not received within the threshold time limit of the preceding beacon signal, the beacon signal counter is reset (step 706) and process 700 starts over at step 702 without sending change in status notification 52. The requirement that a threshold number of successive beacon signals be received from container tag 38 each within a predetermined time period of the one another can mitigate against false notification messages being sent out for container tags that are temporarily located in the vicinity of the compactor and container unit 12. In example embodiments, the threshold number of beacon signals and the rate of such signals can be configured from the central monitoring station 44 based on the requirements of the site 14.

In some example embodiments, RSSI filtering can be applied in steps 702 and 704 to make the process more sensitive to the physical location of container tags within the waste generator site 14. For example, an RSSI range can be set as corresponding to a container tag 38 that has been mounted to a particular waste compactor and container unit 12 of interest, such that process 700 ignores and does not count container tag beacon signals that do fall within the expected RSSI range. Such expected RSSI range could be predetermined absolute range, or could be dynamically determined based on the RSSI of received signals from the compactor tag 36 associated with the waste compactor and container unit 12. The use of RSSI filtering can be useful at sites that have swing containers that can be stored on site, for example. RSSI information can also be provided back to the central monitoring station 44 to allow it to correlate container tags 38 with specific locations within the site 14 at specific times, which can be useful for sites with many compactor and container units. In some example embodiments, timing of container arrivals at a site can be used to associate containers with a particular compactor container unit 12, for example an assumption can be made that the first compactor requesting service or being serviced on site will be the first to receive a container back.

The status change notification message 52 that is sent to the central monitoring station 44 in step 712 can for example include the container tag ID, as well as an indication that the container tag has recently been acquired. Other information such as RSSI information for the container tag could also be included.

Central monitoring station 44 is configured to monitor for and process status change notification messages 52 advising of the arrival of container tags 38 in a similar manner that it monitors for and processes status change notification messages for compactor tags 36, and removal of container tags 38. Referring once again to status change monitoring process 400 illustrated in FIG. 4, once a status change notification message 52 advising of the arrival a container tag 38 is received (step 402), the central monitoring station waits for a predetermined time duration for another status change notice advising of a further change in status of the container tag 38 (step 404), and if no further status change notice is received in respect of the container tag 38, then a service message 54 is then sent out to one or more waste hauler communications devices 46 and/or waste generator communications devices 48. However, if a further status change notice is received in respect of the container tag 38 then the service message 54 is not sent—for example, if the beacon signal is subsequently lost after it has been registered by the site monitoring unit 40, then a status change notice message 52 advising of the lost container tag will be sent as per container removal monitoring process 600, and in such case an assumption is made that the container and compactor unit 12 has not been properly serviced.

The predetermined waiting time applied in step 404 for a subsequent status change notification message 52 for container tag 38 (and its container 16) after receiving a container tag arrival notice could by way of non limiting illustrative example be 115 minutes, or such other amount as set by a system administrator to meet the operating requirements of waste generator site 14. One purpose of the delay in sending the service message 54 is to account for transient movement of container tags through the coverage area of a site monitoring unit 40.

In cases where a service message 54 is sent in respect of a newly acquired container 16, the service message 54 will be sent in dependence on information stored in operations database 56. For example, the container tag 38 can be linked, through using one or more of its unique ID, timing information, and RSSI data, to identification information for the waste compactor and container unit 12 that it is currently mounted to, and to information defining what waste hauler communications devices 46 and/or waste generator communications devices 48 should be provided with service message 54 over what medium. An illustrative example of the content of a service message 54 sent advising that servicing has been completed for a compactor and container unit is as follows: “The Bin #C97 Located at Acme Printing, 10 Queen Street, Toronto, Ontario has been returned, service complete”.

The receive time and content of the status change notification message 52 advising of the container arrival and/or the send time and content of the service message 54 advising of container being serviced can be stored in operations database 56 for future performance analysis.

It will be recalled from the above discussion concerning “Notification That Container Is Being Serviced” that it is possible that the central monitoring station 44 can receive a first status change notification message indicating removal of a container, followed quickly with a subsequent status notification change message indicating the arrival of a container which will result in the service message 54 being aborted if the second status change message is received within a threshold time period. It will be appreciated that the container arrival monitoring process 700 can generate the subsequent status notification change message.

Notification that servicing is complete can also be alternatively detected or confirmed through other information sent to the central monitoring station 44 through site monitoring unit 40 based on signals received from the compactor tag 36 which may for example be configured to detect and report a compactor power up reset on compactor systems that use a power cut-off mechanism when servicing is being conducted. In such a case, the compactor tag 36 may monitored for indications of a power reset when it is known that the subject compactor is currently being serviced. Such monitoring could either supplement or replace monitoring for return of the container tag 38.

### Other Features

In some example embodiments, once a particular compactor and container unit 12 has been serviced, the central monitoring station 44 is configured to not send out any service request service messages for the subject compactor and container unit 12 for a predetermined initial time duration, regardless of what intervening status change notifications are received from the site monitoring unit 40 for the compactor and container unit 12. For example, for a compactor and container unit 12 that typically has a 2 day fill time, the initial delay time for sending out a service request after a service complete message has been sent could be 24 hours. Such initial time delay can be set according to the operating condition of the subject compactor and container unit 12. In some example embodiments, waste hauler trucks 58 can also be equipped with mobile communications devices 60, which can be active RFID tags for example, and which communicate with site monitoring units 40 such that the arrival and departure of waste hauler trucks at the waste generator site 14 can be monitored and tracking information sent back to the central monitoring station 44 and stored in operations database 56. Also, transfer or dumping stations can be equipped with their own monitoring units 40 to detect and track arrival of trucks and containers 16 and provide information about such activities back to the central monitoring station 44. Such tracked information can provide a near real time overview of the operation components of waste management system 12, as well as allow historical analysis for efficiency and bench marking purposes. Such tracking may also be useful to waste generators who may want to track the disposition of waste that may contain for example; confidential information, prototypes, environmentally sensitive waste such as electronic waste or other sensitive waste. Monitoring units that are located on garbage hauling trucks and at waste disposal sites could be configured to register a container in a manner similar to that discussed above in respect of FIG. 7.

As noted above, some compactor monitoring units 26 may include more than one indicator light, for example a “full” light 30 in addition to a “¾ full” light 32. In some example embodiments, a separate compactor tag 36 may be connected to monitor each signal—e.g. a “full” compactor tag 36, and a “¾ full compactor tag”, and the information from such tags used to generate respective status change notification messages similar to those noted above. Alternatively, the information sent by each tag may include more pressure information or other compactor operation information than a simple “ON” or “OFF”, with the compactor monitoring unit using hydraulic and other operating characteristic monitoring methods as described in one or more of U.S. Pat. Nos. 5,299,493; 5,393,642; 6,360,186; 6,408,261; 6,453,270; 6,561,085; 6,738,732; 5,299,142; and 7,145,459.

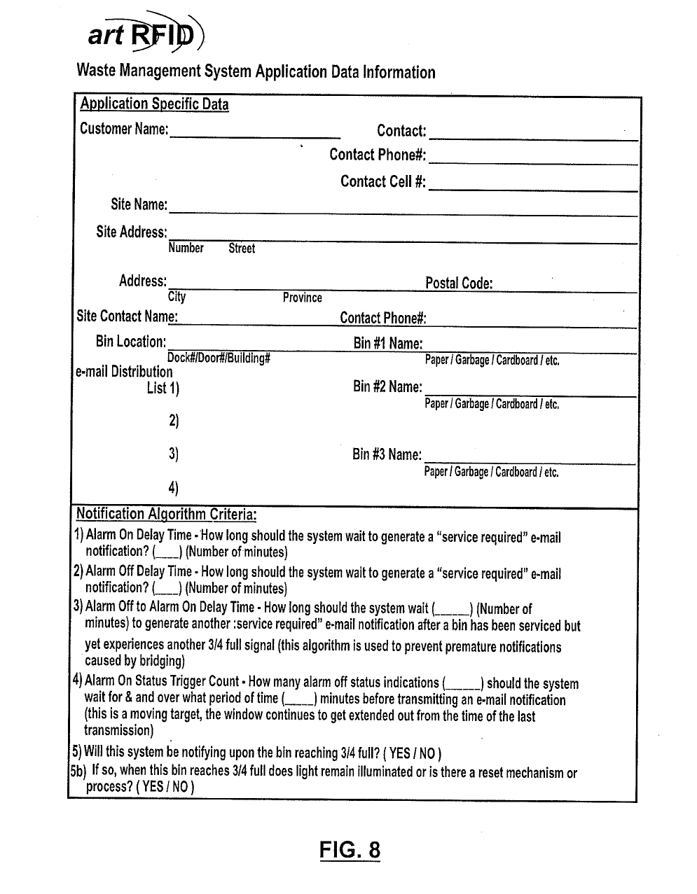

FIG. 8 illustrates a data intake sheet for a waste generator using the waste management system of FIG. 1. Using information from the sheet, an initial time delay for sending out a service request post servicing can be set, as well as the various time and number thresholds identified in the processes of FIGS. 2-7.

In example embodiments, GPS receivers can be attached to or incorporated into one or more of container tag 38, compactor tag 36 and truck tag 60 such that real time location information can be sent to site monitor 40 and then central monitoring station 44. Using GPS information from the tags, the monitoring unit 40 could record and communicate to the central monitoring station 44, status information such as the location a bin was picked up or deposited. In some embodiments waste hauler trucks 58 can be equipped with a monitoring unit similar to a site monitoring unit 40 such that each truck could act similar to a site monitoring unit 40.

In some embodiments at least some of the RFID tags may be passive tags with the site monitoring device including or being connected to one or more suitable readers for interrogating the passive RFID devices. In some example embodiments, one or both of container tag 38 and compactor tag 36 are unidirectional active RFID tags in that they send information to the site monitoring unit 40 but do not received information back from the site monitoring unit 40. In such configurations, the beacon signal frequency and content will be preconfigured for such tags at the time a site 14 is set up. In some embodiments one or both of container tag 38 and compactor tag 36 are bi-directional active RFID tags in that they can also receive information, such as configuration information from the site monitoring unit 40. In some example embodiments, semi-passive RFID tags could be used for one or both of tags 38 and 36—semi passive tags could be used with standard Gen 2 Electronic Product Code interrogators. Semi passive tags are RFID transponders that reflect RF energy back to the reader similar to passive tags but has an onboard sensor.

In example embodiments where a container tag 38 includes or is connected to a motion sensor such as an accelerometer, information from the accelerometer can be sent to the site monitoring unit 40 and used at site monitoring unit 40 or the central monitoring station 44 when determining if a status change notification message or a service message should be sent. In this regard, in some example applications, the waste container 16 may be a type of waste container that does not need to be hauled on the back of a waste hauler truck 58 to a remote dumping site, but rather is a waste container that is configured to be picked up and emptied into a large bin mounted on a truck that includes mechanism for lifting and tipping the waste container. For example, in some waste management systems, FE (“Front End”) equipped waste trucks are used that have hydraulically driven front forks used to pick up specially designed waste containers and dump the container contents into a further waste container mounted on the waste truck. In such cases, tracking when the waste container 16 is tipped a threshold tip angle is a useful metric for determining when a waste container has been serviced. By way of example, waste containers used with vertical compactors at residential multi-unit dwelling sites are often serviced by tipping the waste containers at or near the compactor location. When the container tag 38 includes an accelerometer or other motion sensor information from the accelerometer or other motion sensor can be included in the container signals sent to the site monitoring unit 40, and that information can be relayed to the central monitoring station for processing to determine when and what waste containers have been emptied by tipping.

In at least some tippable waste container applications, as an alternative or in addition to having an accelerometer as part of the container tag 38, the container 16 can include a dedicated container tip tag 60 that is secured to the container 16 in addition to container tag 38, with the container tip tag 60 being configured to send out container signals to the site monitoring unit 40 indicating when the container 16 is tipped a threshold angle that is indicative of the container 16 being emptied, and the container tip tag 60 being configured to continuously send out the container beacon signals in the manner described above to allow the presence of the container to at the compactor to be tracked. Information obtained from both the container “presence” tag 36 and the container “tip” tag 60 can be combined at the central monitoring station to track when and what tippable containers are removed from their respective compactors, when and what containers are subsequently tipped, and when the containers are re-mounted to respective compactors.

In one example embodiment, the container tip tag 60 is an RFID wireless communications device similar to container tag 38 having an associated motion sensor 62 for indicating when the container 16 is tipped the threshold tip angle. By way of example, the motion sensor 62 could include a motion activated mechanical switch that electrically connects two electrical contacts when the container is tipped the threshold tip angle. The mechanical switch can be used to provide a power from a tag battery to the rest of the container tip tag thereby causing the tip tag 60 to begin transmitting container tip tag signals that each include a unique identification information that can be used by one or both of the site monitoring unit 40 or central monitoring station 44 to identify the particular waste container 16 that has been tipped. In such a battery conserving embodiment, a container tip tag 60 only transmits signals when tipped, such that the presence of the container tip tag signal indicates that the tip tag's associated container is being emptied. For example, the tip tag 60 may send out five beacon signals a second in quick succession when powered up. However, the tip tag can take many different forms, for example it could be configured to respond with information measured by an accelerometer when polled by the site monitoring unit 40.

An example of a waste container monitoring application that makes use of container tipping data will now be described in greater detail. In such an embodiment, the fullness state of a plurality of waste compactor units 12 at a waste generator site 14 is monitored based on signals received from compactor tags 36 in the same manner as described above. When a particular container 16 is identified by the monitoring station 44 as requiring emptying, a service message 54 identifying the subject waste compactor unit 12 is generated and sent to a site administrator computer to notify personal at the site 14 that the container 16 is full. In response to the service message, an operator removes the full container 16 and stages it for future emptying, which could for example include taking the container to a tipping location for future emptying, and mounts an empty container 16 to the compactor unit 12. The site monitoring unit 40 detects that the full container 16 has been removed and reports the status change to the central monitoring unit 44 that tracks that the container has been removed. Using such information the central monitoring station can, for example, track the total number of containers that are staged to be serviced (e.g. emptied) at a site. Such information might be used to send a service request to a waste hauler when a threshold number of containers are filled, or used for compliance monitoring in the case of a site that has regularly scheduled pick-up to ensure that the number of containers emptied correspond to the number of containers staged for emptying. The detection of the removal of full container 16 could occur using one or more methods—by way of non-limiting example, the absence of signals from the container presence tag 38 associated with the container could be detected by the site monitoring unit; the subsequent reduction in ram pressure could be detected by the compactor tag 36 and signaled to site monitoring unit 40; and/or activation of a reset switch at the compactor by an operator or otherwise could be detected by the compactor tag 36 and signaled to site monitoring unit 40. Turning again to the full container 16, when a waste hauler subsequently arrives at the tipping location, the site monitoring unit 40 is advised when the container is picked up and tipped (for example, by signals from a dedicated container tip tag 60, or from an alternatively from a container presence tag 38 having an associated motion sensor). The site monitoring unit 40 then passed on a status message to the central monitoring station 44 indicating that the container 16 has been tipped. Using the information gathered throughout this process, the central monitoring station can automatically track and report, by waste generator site 14, when and what compactor units 12 had full containers, when service messages were sent requesting removal of the full containers 16, when and what full containers were removed from the compactor units 12, and when and what containers were tipped by a waste hauler. Information about full container quantities and/or removed containers can be automatically compared at the central monitoring station 44 to information provided by waste haulers about emptied containers and used to ensure that waste haulers comply with their contractual obligations and/or that waste generators are not over charged. By way of example, in some municipalities the waste hauler is on contract to the municipality and the charges to the waste generator are part of a municipal fee. Tracking when containers are full, staged, and then tipped allows for the waste generator to reconcile charges from the hauler to the municipality that in turn are charged to the generator. In some municipalities, any container tipped is deemed to be full, and additional charges are levied to the generator if pre-determined waste reduction targets are not met. These fees are substantial and represent a penalty for the generator, so it is important to the waste generator that all containers put out for service are full and the hauler is only tipping containers that require service.

In some example tippable container applications, the waste containers may not be taken to a tipping location but may instead be removed from the compactor unit 12, emptied at the location of the waste compactor unit 12, and then immediately put back on the compactor unit 12. In such configurations, the information provided by a simple container presence tag 38 that does not detect container tipping may not be sufficient to determine when a waste container has been serviced. In such cases, signals from a dedicated container tip tag 60 or a motion sensor equipped container presence tag 38 can be beneficially monitored by the site monitoring unit 40 to trigger 44 status change notification messages 52 to the central monitoring station 44 so that it can accurately track when containers 16 are serviced at the compactor location.

In some example embodiments, especially where waste containers are serviced through emptying at the compactor location, the container presence tag 38 can be omitted in place of a dedicated container tip tag 60 as the service status of container 16 may in at least some circumstances be more adequately determined by its tip status than its location status in such applications.

In some example embodiments a dedicated ram cycle counter tag is included on the compactor 18 and configured to transmit a beacon signal with a unique identifier to the site monitoring unit 40 each time the compactor ram 20 executes a compression signal. For example, the ram cycle counter could be connected to transmit the beacon cycle whenever a drive signal is provide to the ram. The site monitoring unit 40 in turn relays ram cycle count information to the central monitoring station 44 which can use such information to provide servicing request messages for the compactor unit when predetermined ram cycle thresholds are met.

Embodiments of the invention relate to the monitoring of waste compactor systems, and more specifically the monitoring of both the fullness level of at least one receptacle container or bin attached to a compacting device and the location of at least one removable receptacle or bin, associated with the compactor, allowing an intended recipient to receive information when a waste compactor system is at or near capacity and requires service and when the removable bin was removed and returned or a new receptacle or bin replaced it, and when the compactor system was returned to service.

According to one aspect of the invention is a monitoring system for a waste compactor system comprising: a compacting device; at least one removable waste container; a sensor for determining the fullness level of the receptacle or bin; a compactor communications device responsive to the sensor for transmitting an indication of the fullness level of at least one receptacle or bin; a container communications device attached to the at least one removable waste container; a communications device to communicate with the container communications device and the compactor communications device.

In an example embodiment, compactor fullness and the movement of the removable container or bin is managed as an entire system. In one example embodiment, wireless transmitters such as active rfid (radio frequency identification device) tags are attached to both the compacting device and the removable container or bin. The active rfid tag attached to the compacting device comprises the ability to monitor some status of the compactor, such as an electrical circuit indicating some predetermined status of fullness. Many industrial compactors manufactured by OEMs (Original Equipment Manufacturers) have the ability to adjust the pressure exerted by the hydraulic ram and are designed to sense when hydraulic pressure reaches predetermined settings, and illuminate a light on the compactor control unit indicating to operators the fullness status of the container or bin. In one embodiment of this invention, an active rfid tag comprising the ability to sense a current in a circuit is attached to the appropriate circuit associated with the light. The rfid tag monitors the circuit and wirelessly sends a message indicating when there are changes in the circuit. In this embodiment an rfid reader receives the wireless message from the tag, and may or may not conduct some logic associated to whether the message should be forwarded. If the reader's logic determines that this message should be forwarded, it can be sent to a predetermined recipient through a variety of options. The reader could be connected to a standard telephone line, the Internet, a computer Ethernet system or a cellular modem to forward the message to an intended recipient. In an example embodiment the message is sent to an off site central monitoring computer system and data base, where additional business rules, business logic or algorithms may be applied before a message is sent to an intended recipient alerting them as to the fullness status of the container or bin. The business logic or algorithms can be modified to control the terms upon which the message is sent. For example, a condition known as ‘bridging’ can occur when the compactor may signal that it has reached some predetermined fullness capacity when in reality the material in the compactor is forming a layer in the bottom of the container or bin and the hydraulic ram is unable to fully compact the material until additional ram cycles occur. In some embodiments the customer can access the business rules or business logic via a web based portal and modify the rules under which a message is sent to an intended recipient and dedicate which recipient(s) should receive the message. For example the business rules may be set to require 5 hydraulic ram cycles, each one of which generated a status message that the predetermined fullness level had been reached before a message to an intended recipient is generated. This might overcome most instances of bridging in this application and prevent premature notification of the compactor being full, and a service call by a waste hauler. The message may be in the form of an email, SMS, fax or other electronic notification. Via this same web portal a customer could also add delete or modify the emails or other address and identities of the intended recipients.

In this same embodiment active RFID tags are also attached to the removable container or bin, and are monitored wirelessly by the RFID reader. When bins are detected by the reader as having been removed from the compacting device, a message is forwarded by the reader, via similar methods as described above. When the bin has been returned another message is generated. In some instances ‘swing’ bins may be already placed on site to replace the bin that has been removed and are tracked where they may be on site and when they are utilized. The RFID tags mounted on the containers or bins can be associated with each bin's identity providing a real time tracking of where all containers or bins are located either on a site or across a company or geographical area where the Compactor and Bin Monitoring System is deployed.

In example embodiments the compactor system comprising of both the compactor and the removable containers or bins can be monitored and managed as one system. Real time data can be obtained as to when the compactor has compressed waste in the removable containers or bins to a predetermined level. Notifications such as emails can be sent to various recipients, such as notification to haulers to service the compactor. Real time data can be obtained as to how long to took the hauler to respond and haul away the container or bin and how long the hauler took to return it an put the compactor back into service.

Operating data from the compactor and bins is retained in a database so that reports can be generated to measure such elements as efficiencies, performance of haulers, cost savings, GHG (green house gas) reductions due to reduced pick up requirements etc.

We claim:

1. A monitoring system for a waste compactor system that includes a waste container and a compactor for compacting waste in the waste container, wherein the waste container is removable from the compactor for emptying, the monitoring system comprising:
a compactor communications device for receiving information about a fullness level of the waste container from a compactor monitoring unit and sending wireless compactor signals indicating a fullness level status for the waste container;
a waste container communications device secured to the waste container for sending wireless container signals that include information for identifying the waste container; and
a site monitoring unit monitoring the wireless compactor signals from the compactor communications device and the wireless container signals from the waste container communications device and sending status messages over a communications link in dependence on the monitoring of the compactor signals and container signals.

2. The monitoring system of claim 1 comprising a monitoring station configured to receive the status messages from the site monitoring unit over the communications link and to determine a service status of the waste container in dependence thereon.

3. The monitoring system of claim 2 wherein the waste container communications device is configured to periodically send the container signals, the site monitoring unit being configured to determine a location of the container relative to the compactor in dependence on the container signals and to include information indicating changes in the location of the container in the status messages sent over the communications link, the monitoring station being configured to determine whether a waste container is being serviced in dependence on the information indicating changes in the location of the container.

4. The monitoring system of claim 2 wherein the waste container communications device is configured to periodically send the container signals and the site monitoring unit is configured to determine that the container has been removed from the compactor when container signals from the container are not received for a predetermined threshold and to include information indicating the removal changes in the status messages sent over the communications link.

5. The monitoring system of claim 2 wherein the site monitoring unit is configured to determine that the container has been removed from the compactor when the container signals are absent for a predetermined duration after being present.

6. The monitoring system of claim 2 wherein the site monitoring unit is configured to determine that the container has been removed from the compactor in dependence on the received signal strength of the container signals.

7. The monitoring system of claim 2 wherein the container signals include periodic beacon signals.

8. The monitoring system of claim 2 wherein:
the compactor communications device is configured to periodically send the wireless compactor signals;
the site monitoring unit is configured to monitor successive wireless compactor signals to determine when a threshold number of successive wireless compactor signals indicate a change in the fullness level status for the waste container and send at least one status message over the communications link indicating the change in fullness level status; and
the monitoring station is configured to determine a change in the service status of the waste container when a threshold time has passed since receiving the status message indicating the change in fullness level status and no additional status message has been received indicating a further change in fullness level status.

9. The monitoring system of claim 1 wherein the compactor communications device and the waste container communications device each include a respective radio frequency identification (RFID) tag.

10. The monitoring system of claim 1 wherein a motion sensor for sensing motion of the waste container is associated with the waste container communications device, the container signals indicating when the waste container is moved at least a threshold amount in dependence on a signal received from the motion sensor, the site monitoring unit being configured to include in one or more status messages information indicating the waste container has moved in dependence on the container signals.

11. The system of claim 10 wherein the motion sensor includes a tip sensor for detecting when the waste container is tipped beyond the threshold.

12. The system of claim 11 wherein the tip sensor is configured to control power to the waste container communications device such that the waste container communications device only sends wireless signals after the waste container is tipped at least the threshold amount.

13. The system of claim 12 including a further waste container communications device that continuously sends a periodic further wireless signal that also includes information for identifying the waste container, the site monitoring unit being configured to detect a change in location of the waste contactor relative to the compactor by monitoring for the further wireless signal.

14. An automated method for monitoring a waste compactor system that includes a compactor for compacting waste in a removable waste container, the method comprising:
monitoring for compactor signals from a compactor monitoring unit indicating a fullness level status for the waste container;
monitoring for wireless container signals from a waste container communications device secured to the waste container, the container signals including information for identifying the waste container; and
determining status changes for the waste compactor system in dependence on the monitoring.

15. The method of claim 14 comprising sending status change messages to a remote location over a communications link, wherein determining status changes includes determining if the waste container has moved relative to the compactor in dependence on at least one of (i) the presence or absence of the container signals or (ii) the received signal strength of the container signals.

16. The method of claim 14 wherein the waste container communications device includes a motion sensor for detecting when the waste container has been emptied, the wireless container signals indicating that the waste container has been emptied, and wherein determining status changes includes determining when wireless container signals are received indicating that the waste container has been emptied.

17. A monitoring system for a waste compactor system having a compactor for compacting waste in a removable waste container, the monitoring system comprising a wireless communications device secured to the removable waste container and having an associated container movement sensor for detecting when the waste container is emptied, the communications device being configured to transmit one or more wireless signals indicating when the waste container has been emptied.

18. The monitoring system of claim 17 wherein the container sensor comprises a mechanical switch that provides a power signal to the communications device when the waste container is tipped at least a threshold tip angle thereby enabling the communications device to transmit the one or more wireless signals.

19. The monitoring system of claim 17 further comprising:
a site monitoring unit for monitoring for the one or more wireless signals to determine if the waste container has been emptied and sending a status message over a communications link upon determining that the waste container has been emptied; a remote monitoring station for receiving the status message and storing information indicating when the waste container has been emptied.

20. The monitoring system of claim 19 wherein the waste container is configured to be removed from the compactor to a tipping location prior to being tipped, and the site monitoring unit monitors for wireless container signals from the waste container to determine if the waste container has been removed from the compactor and sends information over the communications link indicating the removal, the remote monitoring station being configured to receive the information and store information identifying when the waste container was removed, the remote monitoring station being further configured to generate a report in dependence on the stored tipping information and stored removal information for the waste container.
